(19) United States
(12) Patent Application Publication
(10) Pub. No.: US 2022/0055825 A1
(43) Pub. Date: Feb. 24, 2022

(54) Pressurized Beverage Container with a Portion Having a Function Associated with Immersion in a Beverage

(71) Applicant: Sean McNicholas, Old Harlow (GB)

(72) Inventor: Sean McNicholas, Old Harlow (GB)

(21) Appl. No.: 16/997,261

(22) Filed: Aug. 19, 2020

(51) Int. Cl. B65D 85/73; B65D 51/28; A47G 19/22; B65D 51/24; B65D 43/02; C12C 11/11; B01F 3/04; B01F 15/00

(52) U.S. Cl. CPC B65D 85/73; B01F 2215/0068; A47G 19/2288; B65D 51/242; A47G 19/2233; B65D 43/0212; C12C 11/11; B01F 3/04794; B01F 15/00779; B65D 2543/00092; B65D 2543/00527; B65D 2543/00537; B65D 2543/00833; B01F 2003/049; B65D 51/2807

(57) ABSTRACT

A pressurized beverage container comprising a receptacle with an internal area, an opening and a lid covering said opening, in which said lid comprises a releasable section which is manually movable from a sealed position in which it forms a functional covering part of said lid, to an open position in which it is displaced from a remainder of said lid such that an aperture is formed in said lid, in which said lid comprises a tail part, in which said tail position is movably associated with said releasable section such that during at least part of said manual movement of said releasable section from said sealed position to said open position said tail part travels inwardly into said internal area, and in which said tail part comprises a function associated with immersion in a beverage.

The present invention relates to a pressurized beverage container with a releasable section having a tail part comprising a function associated with immersion in a beverage, for use particularly, but not exclusively, as a pressurized beer glass with an internal gas release vessel.

Single-serving pressurized beverage containers such as a tin can of cola are well known, and usually comprise a metal tin with a deflection tab on the top which can be rotated to displace a weakened section of the top in order to form a small aperture. Such tins are simplex in order to reduce material and manufacturing costs, and are not designed to function in more than one way. The user manipulates the deflection tab to form the small aperture, and either pours the contents from the can into another receptacle, or drinks directly therefrom. An inherent issue with such tins is that it is not particularly pleasant, or in some cases polite, to drink directly from them. The aperture is small which can lead to excessive foaming of any carbonated beverage passing therethrough, which affects taste and enjoyment, and can also lead to spillage and waste. Further, it is known that such tins can carry bacteria, germs or dirt on their upper surfaces, in particular if they have been exposed to a public space for a long time, and the user is directly exposed to this when drinking from the tin. However when no other receptacle is available this is the only option.

It is known to provide beverage glasses with a removable lid. This allows the user to enjoy consuming the beverage from such an open topped receptacle, which may be preferred. However, to date this has only ever been done with still beverages such as water, fruit juices or wine, and as such the removable lid is normally nothing more than a thin foil or sheet of plastics material attached to a rim of the glass with an adhesive. It would not be possible to use such a construction with a larger quantity of beverage, or with a pressurized beverage.

In recent years some pressurized beverage containers, namely cans of beer, have been provided with gas release vessels inside them, known as widgets. These devices can work in a number of different ways, but in essence they contain a pressurized gas (or sometimes a gas mixed with a liquid) which is released into the beverage through a small aperture when the container is opened to atmosphere. As the pressurized gas exits the gas release vessel it agitates the beverage over a period of time, either as a result of the escape of the gas bubbles from the aperture, or by virtue of the mixing of the gas into the beverage itself as it is depressurized. In any event, when this is done with a beverage such as beer it leads to the formation of a foamy head of bubbles, which enhances the experience of consuming the beer. It has been known to provide widgets like this which are free floating in the beverage, as well as constructions in which the widget is mounted to an internal surface of the container or in a particular position therein. There are various different ways such pressurized containers can be manufactured. In some cases the widget is pre-filled with the pressurized gas, and is only opened up as part of the opening procedure for the main container. In other cases the widget is filled with pressurized gas and liquid as part of the beverage filling process. In particular, an empty widget is placed in the beverage before a gas is then introduced to increase the pressure. The container is then closed, and the internal pressure forces the gas or a mix of the gas and some of the beverage into the widget through the small aperture. The pressurized gas or gas and liquid mixture remains inside the widget until the container is opened to atmosphere. The gas then escapes from the widget over a period of time after the container has been de-pressurized.

An inherent issue with widgets is that they need to be contained within the container so they cannot be accidentally consumed by the user. This means that widgets would not find ready application with beverages packaged in open topped receptacles such as glasses with a removable lid.

The present invention is intended to overcome some of the above described problems.

Therefore, according to a first aspect of the present invention a pressurized beverage container comprises a receptacle with an internal area, an opening and a lid covering said opening, in which said lid comprises a releasable section which is manually movable from a sealed position in which it forms a functional covering part of said lid, to an open position in which it is displaced from a remainder of said lid such that an aperture is formed in said lid, in which said lid comprises a tail part, in which said tail part is movably associated with said releasable section such that during at least part of said manual movement of said releasable section from said sealed position to said open position said tail part travels inwardly into said internal area, and in which said tail part comprises a function associated with immersion in a beverage.

Thus, the first aspect of the present invention provides a pressurized beverage container which can be opened by moving the releasable section to the open position, but which at the same time involves moving the tail part so its function associated with immersion in a beverage is performed. In addition, this beverage immersion function is performed without any independent floating component being needed. As outlined below, the beverage immersion function can be the known widget function to agitate the beverage so as to form a foamy head on beer.

The tail part can be movably associated with the releasable section in any way, which can include an arrangement in which the releasable section and the tail part are not connected to one another, but movement of the releasable section is transmitted to movement of the tail position by any kind of transmission part, such as a lever or the like. Furthermore, the tail part can be located in any position when the releasable section is in the sealed position, including being above the internal area and being already located in the internal area. All that is necessary is for the tail part to travel inwardly into the internal are when the releasable section is moved into the open position.

However, preferably a beverage can be disposed in the internal area and the tail part can extend from the releasable section and be arranged above the beverage when the releasable section is in the sealed position and the container is arranged with the opening uppermost. With this construction the tail part is kept out of the beverage when the container is arranged with the opening uppermost.

In one possible version of the invention the lid can be a single integrally formed article, the tail part being integrally formed with the releasable section, and the releasable section being integrally formed with the remainder of the lid. With this construction the lid can be made from a moulded plastics material, and can basically comprise a panel made up of the lid body itself, including the releasable section, with the tail part extending from a location on an underside thereof adjacent to an inner end of the releasable section.

However, preferably the tail part can be a separate part to the remainder of the lid, and can be attached to the releasable section by a connection mechanism. With this construction the lid can be made from a moulded plastics material, and can basically comprise a panel made up of the lid body itself, including the releasable section. The tail part can then be made from any material suitable for its function, and can be attached to a region of an underside of the releasable section which changes position and/or orientation when the releasable section is moved from the sealed position to the open position, such that a corresponding movement is transmitted to the tail part. The connection mechanism can be of any known kind, including a fixing such as a staple, pin or screw, but preferably a suitable adhesive is used.

The releasable section can be manually rotatable about an axis dissecting the lid, such that the releasable section rotates upwardly from the remainder of the lid and the tail part rotates downwardly into the internal area when the releasable section is moved from the sealed position to the open position and the container is arranged with the opening uppermost. As such, the movement which is transmitted from the releasable section to the tail part is a corresponding rotational movement.

Preferably the lid can be manually removable from the container. This allows a pressurized beverage container to be used in the conventional manner by drinking or pouring from the aperture in the lid, but also by fully removing the lid and drinking from an open topped receptacle such as a glass or mug for more comfort and convenience.

The tail part can have any function associated with immersion in a beverage in the container. This could be anything from introducing an ingredient, a colourant or any kind of physical trigger which changes the nature, condition or temperature of the beverage or creates some other physical effect. However, in a preferred construction the tail part can comprise a gas release vessel for releasing pressurized gas into a beverage disposed in the receptacle. In other words, the tail part can be a widget device. As discussed above, there are various different known kinds of widget, such as pre-filed, or those which are filled during the beverage filling process, and the invention can work with any of them. (The term “gas release vessel” used herein refers to the primary gas releasing function thereof, but it will be appreciated that in use often there is also some of the beverage inside a widget too. Hence the term “gas release vessel” is used in a general sense to mean a vessel which can contain and release pressurized gas and/or gas and liquid mix.)

In constructions in which the tail part comprises a gas release vessel, the feature that the tail part is arranged above the beverage when the container is arranged with the opening uppermost becomes relevant. This feature is important for the gas release vessel because it allows for a more effective widget function. In particular, in versions of known products in which the widget is either free floating or located in a submerged position in the beverage, when a pressurizing substance such as liquid nitrogen is introduced into the beverage filled container just prior to it being sealed, the liquid nitrogen mixes with the beverage and pressurizes it, and this mixture then forces its way into the widget. As such, the contents of the widget are often of the same composition and pressure as the beverage in the rest of the container. When the container is depressurized the widget functions by depressurizing more slowly than the rest of the beverage, because the pressure inside it can only escape through the small aperture. This flow of fluid out of the widget causes bubbles to form in the beverage, creating the foamy head.

However, it is known that a more effective widget function is achieved if the widget contains only pressurized gas, for example pressurized nitrogen. This occurs in the present case because when the liquid nitrogen is introduced to the receptacle during manufacture and the container is then sealed, this pressurized gas forces its way into the gas release vessel above it. Provided the container remains with the opening uppermost, the gas release vessel will remain free of beverage. As such, when the gas release vessel is rotated down into the beverage as the pressure inside the container is released, only the pressurized gas will escape therefrom, leading to a greater generation of bubbles and agitation of the beverage, and a better foamy head.

In line with the above, in a preferred construction the gas release vessel can comprise a gas release aperture which is open to the internal area. As such, gas introduced to the container during manufacture is free to enter the gas release vessel.

As mentioned above, when the releasable section is in the open position it extends upwardly from the remainder of the lid and the tail part extends downwardly into the internal area. In this position the releasable section can be moved back and forth in a reciprocating action by the user about its axis of rotation. This allows the gas release vessel to be manually agitated by the user, which can lead to an enhanced widget effect. This kind of manual manipulation of a widget has never been possible before.

In another envisaged embodiment the tail part can instead comprise a refrigeration device for cooling a beverage disposed in the receptacle. Such a refrigeration device can be any of the known constructions which generate a physical cooling effect when physically activated in some way, for example by the combination of two materials which creates a cooling chemical reaction, by the release of a pressurized fluid from a container, or by the use of electrical componentry of some kind.

In yet another version of the invention the tail part can comprise a gas release vessel for releasing a pressurized gas intro a beverage disposed in the receptacle and a refrigeration device for cooling said beverage. With this construction the widget effect is combined with a cooling effect so a foamy head can be generated at the same time as the beverage is cooled to enhance the consumption experience.

The container, the lid and the tail part can be any shape, for example square or hexagonal. However, preferably the opening can be annular, the lid can be annular, and the tail part can be annular and co-axial with the opening. This annular shape is suitable for use with a round beer glass. The annular shape of the tail part allows it to have a large radial volume, so a sufficient internal volume can be achieved while maintaining a low height.

Obviously, the lid has to be constructed from a material capable of withstanding the pressure inside the container, but preferably it is also constructed from a resilient material such that it can be manually removable from the receptacle by being manually distorted. This is something which can be readily determined by the skilled person using their common general knowledge of the field, and as such it is not an area which is described herein in any great detail. However, resilient or flexible materials such as a polypropylene or polyethylene plastics material, or a malleable metal can be used.

In a preferred embodiment the lid can comprise an outer edge, and a first side of the releasable section can be formed by a portion of the outer edge. As such, the formed aperture extends from a rim of the receptacle rather than from a location in the middle or centre of the lid, as is the case with known pressurized can constructions.

The releasable section can be any shape suitable for creating an aperture, such as a semi-circular shape, a triangular shape, or any other geometric shape. It can also be entirely removable from the lid if desired. However, in a preferred construction the releasable section can be defined by weakened sections of the lid extending from the outer edge to the fold line about which the releasable section is rotatable, and the releasable section can remain connected to the remainder of the lid in the open position. This allows for the releasable section to be movable from the open position back to a closed position in which the first side is disposed in substantially the same position as it was in the sealed position. Therefore the closure of the aperture in this way may still be a practical and advantageous feature in use to prevent general spillage.

The weakened sections can be any shape, but preferably the releasable section can be defined by a pair of straight weakened sections of the lid extending from the outer edge to the fold line. These can be parallel lines, or lines which are angled in relation to one another.

The lid can comprise a sealing area adjacent to the outer edge which can be in sealing connection with a rim of the receptacle when the lid is in a mounted position on the receptacle. This can be achieved an any of the known ways, for example by using an adhesive or a mechanical crimping.

In an alternative embodiment of the invention to that described above in which the tail part is attached directly to the releasable section, the container can comprise a separate activation lever part, which can serve to move the releasable section from the sealed position to the open position, and which can also comprise the tail part.

Namely, the activation lever can be disposed between the lid and the rim, which lever can be movable from a stand-by position in which it is in sealing connection with the rim to an activation position in which it is displaced from the rim, The lever can be connected to the releasable section such that movement of the lever from the stand-by position to the activation position moves the releasable section from the sealed position to the open position. With this construction the releasable section can be moved to the open position by manual manipulation of the lever, rather than by direct manual manipulation thereof.

At least a portion of the lever which is in contact with the releasable section can be constructed from a generally rigid material, such as metal, while the lid can be constructed from something more resilient or flexible, as mentioned above. As such, manual movement of the lever will result in distortion of the lid, and not the opposite. (However, as explained below the lever can have a handle portion which can rotate relative to the rest of the lever, and in at least one version of the invention the lever can comprise a lever fold line designed to fold under less force than that required to displace the releasable section.)

Preferably the lever can comprise a handle, a mid-portion connected to the releasable section, and the tail part extending beyond the releasable section. Therefore, during at least part of the movement from the stand-by position to the activation position the lever can rotate such that the tail part travels inwardly into the internal area. This rotation will be about the fold line, by virtue of the connection between the lever and the releasable section, however its exact position will depend on the particular distortion experienced by the lid in question when the lever is rotated and the releasable section moved.

In embodiments comprising an activation lever the function associated with immersion in a beverage can be any of those mentioned above, and they are provided by components carried on the tail part of the activation lever. In versions in which the tail part carries a gas release vessel thereon, the lid can comprise a raised housing section inside which the gas release vessel can be disposed when the lever is in the stand-by position, such that the gas release vessel can be arranged above the beverage disposed in the receptacle when the container is arranged with the opening uppermost.

As also mentioned above, the gas release vessel can comprise a gas release aperture which is open to the internal area. However, in an alternative construction the gas release vessel can be pre-filed with pressurized gas. This is an alternative possible manufacturing method which may be preferred. Therefore, in embodiments comprising an activation lever, the gas release vessel can comprise a gas release aperture which is closed to the internal area when the lever is in the stand-by position.

The gas release aperture will have to be opened during the opening process, and this can be done using any known mechanical technique. For example, it can be pierced as part of the movement of the lever, or simply distorted so an opening is created. However, in a preferred construction the gas release aperture can be closed with an adhesive strip. A rear side of the adhesive strip can be attached to the lid, so when the lever is moved from the stand-by position to the activation position the adhesive strip can be removed from the gas release aperture so as to open it to the internal area.

It is also possible for the gas release vessel to comprise a gas release aperture which is closed to the internal area in embodiments in which the tail part is attached directly to the releasable section and there is no activation lever. Once again, any technique can be used to open the gas release aperture, including the use of an adhesive strip, a rear side of which can be attached to the lid so when the tail part is moved the strip is removed from the gas release aperture.

As referred to above, the sealing area can be sealed to the rim of the receptacle in any known way. However, in a preferred construction the rim can comprise a rounded outwardly facing lip, and the sealing area can comprise a portion of the lid which is sealed to a portion of the lip. Preferably the lid can be folded down over a top and a side of the lip, and it can comprise an inwardly facing flange portion applied to a bottom of the lip. A crimp can then be applied to the flange portion to seal it against the bottom of the lip. This is an effective way to secure the lid to the receptacle so it can withstand the pressure therein.

In embodiments comprising an activation lever, in the stand-by position the handle can be arranged substantially parallel with a side of the receptacle and at an oblique angle to the mid-portion. As such, the lever is also folded down over the top and the side of the lip, and the handle is neatly stowed next to the side of the receptacle. The lever can be so applied to the lip that a seal is created, and this can be done by forcing it into a substantially silhouette shape.

The lever can be so formed that it maintains this substantially “L” shaped configuration during use, and in particular when the lever is moved from the stand-by position to the activation position. However, preferably the handle can rotate relative to the mid-portion, such the lever can be bent by the user into more of a linear shape. In order to achieve this a lever fold line can be provided between the handle and the mid-portion. This can function in one of two different ways. In a first embodiment the lever and the lid are configured such that the lever fold line folds under less force than that required to displace the releasable section from the remainder of the lid. As such, when the user first moves the handle it rotates outwardly from the receptacle until it is substantially in line with the mid-portion and the lid. When it reaches this point it can rotate no more and force applied thereto leads to the tearing of the weakened sections of the lid, and the movement of the releasable section from the sealed position to the open position. At the same time, the tail part is rotated down into the beverage.

In another embodiment the lever and the lid can be configured such that the lever fold line only folds under a greater force than that required to displace the releasable section from the remainder of the lid. As such, all movement of the handle from the stand-by position to the activation position is transmitted to the mid-portion, the releasable section and the tail part. However, when the tail part eventually abuts against an internal surface of the container it provides sufficient resistance to the lever that further force applied to the handle folds it about the lever fold line relative to the mid-portion.

Whichever of the above three possibilities is used, it will be appreciated that when the lever is in the activation position the handle is located above the opening. In this position it can be moved back and forth in a reciprocating action by the user about its axis of rotation, which as explained above is in the region of the fold line formed in the lid. This allows the gas release vessel to be manually agitated by the user, which can lead to an enhanced widget effect. This kind of manual manipulation of a widget has never been possible before.

It will be appreciated that it would be possible to manufacture and sell the lid component of the above described first aspect of the present invention separately, for manufacturers to fit to receptacles such as pint glasses. Therefore, according to a second aspect of the present invention a lid for covering an opening of a receptacle part of a pressurized beverage container containing a beverage disposed in an internal area thereof is provided, in which said lid comprises a releasable section which is manually movable from a sealed position in which it forms a functional covering part of said lid, to an open position in which it is displaced from a remainder of said lid such that an aperture is formed in said lid, in which said lid comprises a tail part, in which said tail part is movably associated with said releasable section such that during at least part of said manual movement of said releasable section from said sealed position to said open position said tail part travels inwardly into an internal area of a receptacle part with which it is used, and in which said tail part comprises a function associated with immersion in a beverage.

The present invention can be performed in various ways, but three embodiments will now be described by reference to the accompanying drawings, in which:

FIG. 1 is a perspective view of a pressurized beverage container according to the first aspect of the present invention in the sealed position;

FIG. 2 is a cross-sectional side view of the container shown in FIG. 1;

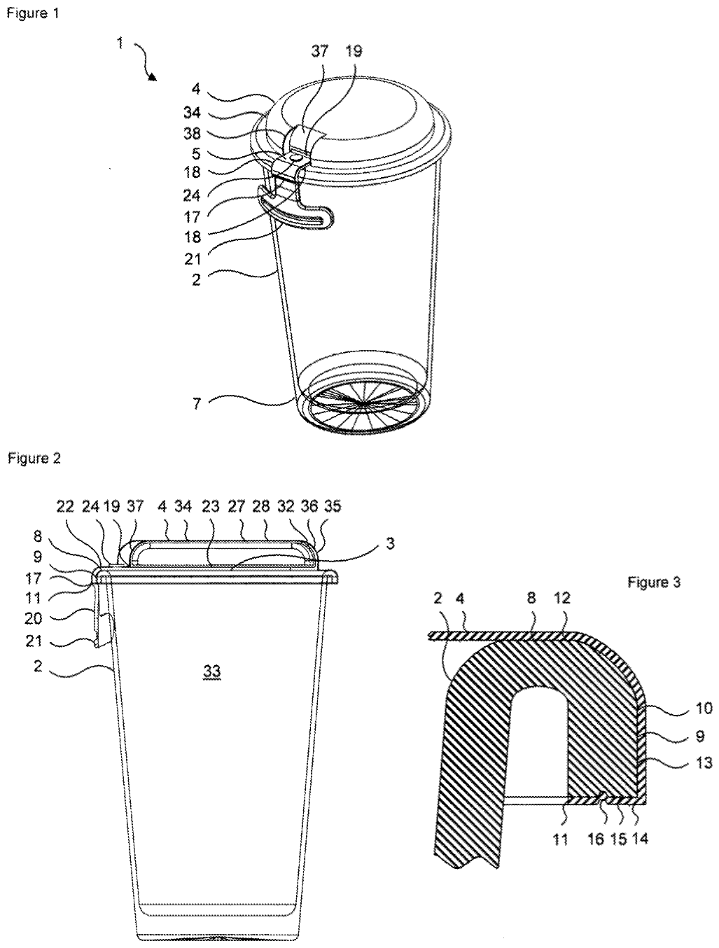

FIG. 3 is a cross-sectional detail view of the container shown in FIG. 1;

FIG. 4 is a cross-sectional detail view of the container shown in FIG. 1;

FIG. 5 is a perspective view of the container shown in FIG. 1 in the open position;

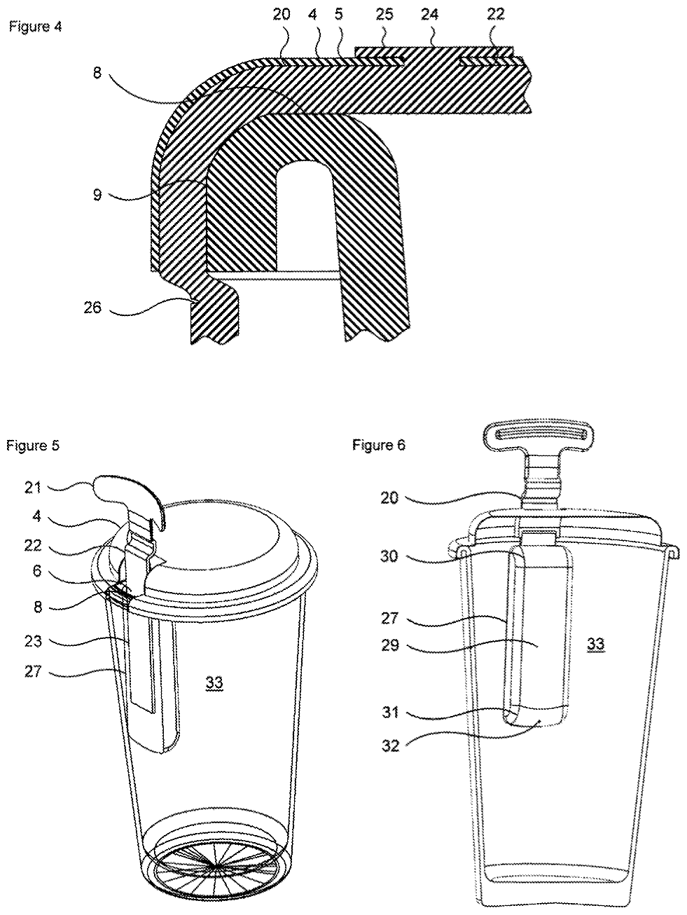

FIG. 6 is a perspective cross-sectional view of the container shown in FIG. 5;

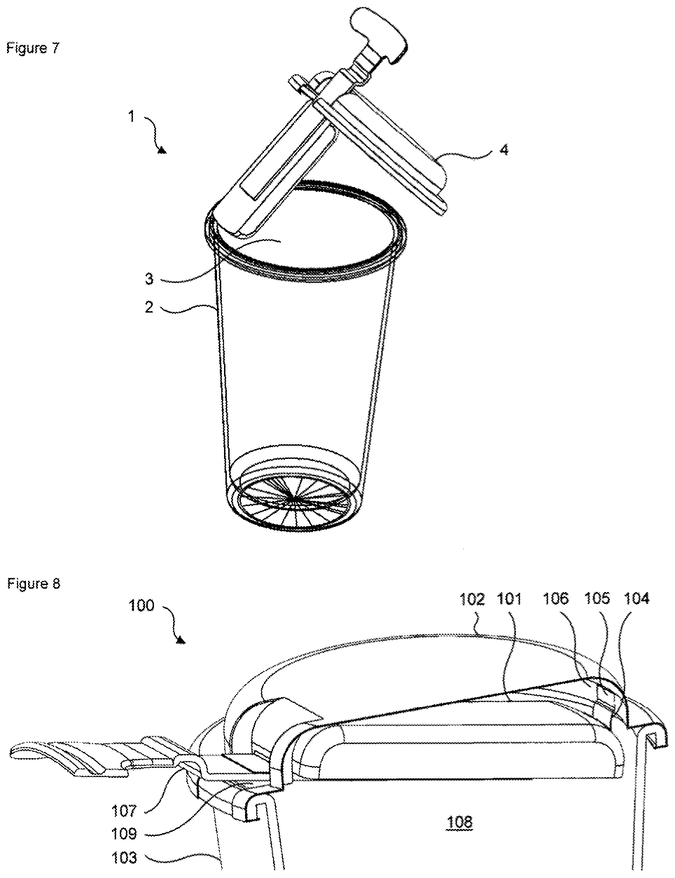

FIG. 7 is a perspective view of the container shown in FIG. 1 with the lid component thereof removed;

FIG. 8 is a perspective cross-sectional detail of a second pressurized beverage container according to the first aspect of the present invention;

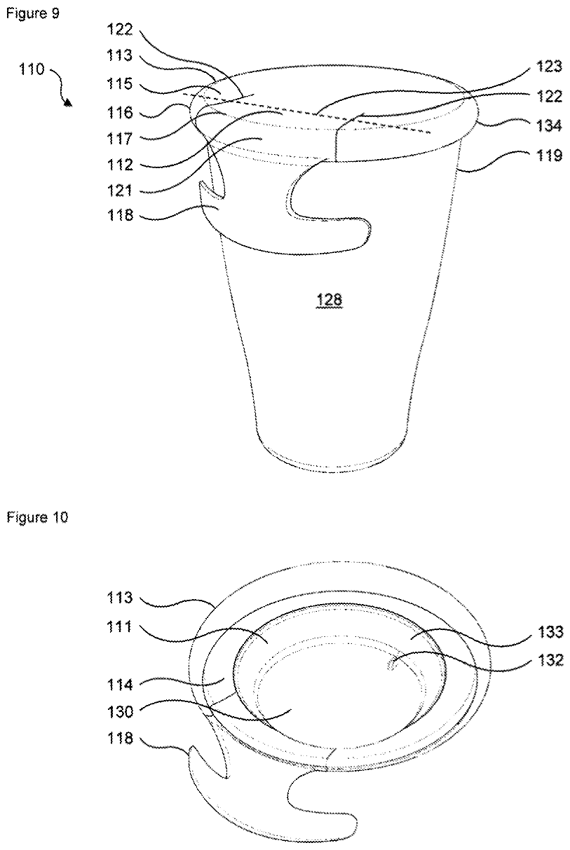

FIG. 9 is a perspective view of a third pressurized beverage container according to the first aspect of the present invention in the sealed position;

FIG. 10 is a perspective underside view of the lid component of the container shown in FIG. 9;

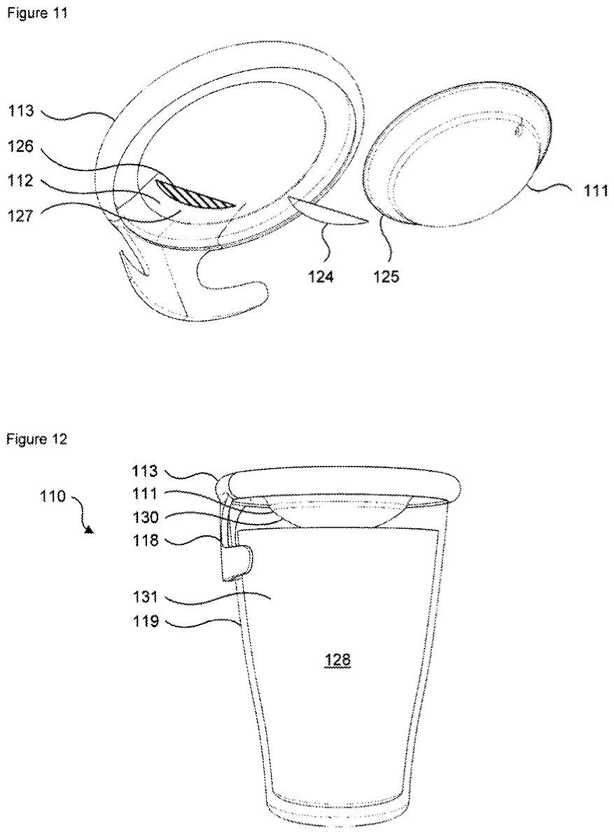

FIG. 11 is an exploded perspective underside view of the lid component shown in FIG. 10;

FIG. 12 is a side view of the container shown in FIG. 9;

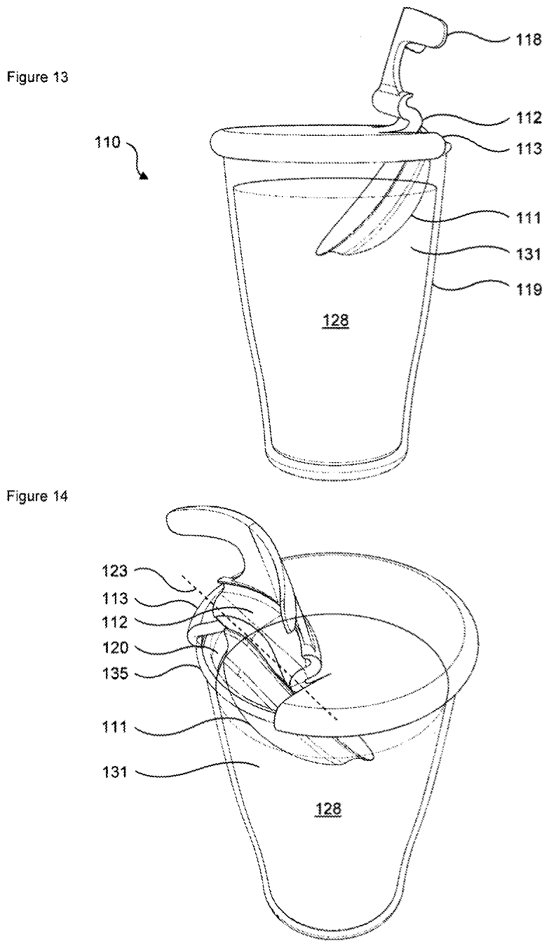

FIG. 13 is a side view of the container shown in FIG. 9 in the open position;

FIG. 14 is a perspective view of the container shown in FIG. 9 in the open position;

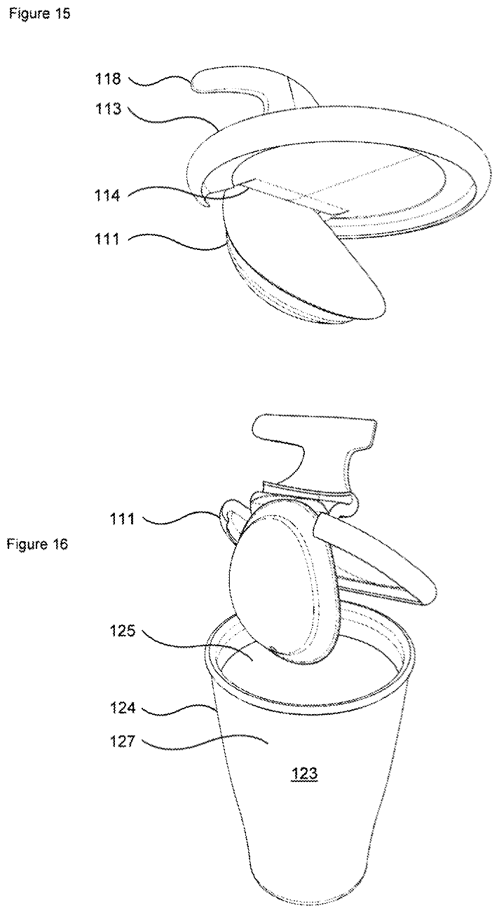

FIG. 15 is a perspective underside view of the lid component shown in FIG. 10 in the open position; and,

FIG. 16 is a perspective view of the container shown in FIG. 9 with the Id component thereof removed.

As shown in FIG. 1, a pressurized beverage container 1 comprises a receptacle, in the form of glass 2, with an internal area 33, an opening 3 (visible in FIG. 7) and a lid 4 covering the opening 3. As explained in further detail below, the lid 4 comprises a releasable section 5 which is manually movable from a sealed position, as shown in FIGS. 1 and 2, in which it forms a functional covering part of the lid 4, to an open position, as shown in FIGS. 5 and 6, in which it is displaced from the remainder of the lid 4 such that an aperture 6 is formed in the lid 4. The lid 4 further comprises a tail part 23, which is movably associated with the releasable section 5 such that during at least part of the manual movement of the releasable section 5 from the sealed position to the open position the tail part 23 travels inwardly into the internal area 33. As explained in further detail below the tail part 23 is part of an activation lever 20, and comprises a function associated with immersion in a beverage in the form of gas release vessel 27 carried thereon.

The glass 2 is like a known beer glass. It has a weighted base section 7, and a shape which tapers outwardly from the base section 7 to a rim 8. It is transparent, and has an internal volume of substantially one pint. In use the glass 2 contains pressurized beer (not shown), which is placed therein and pressurized according to any of the known manufacturing methods. For example, the beer can be placed in the glass 2, and then a quantity of liquid nitrogen is then also placed in the glass 2 prior to the lid 4 being fitted to the opening 3 to seal the glass 2 closed. The liquid nitrogen mixes with the beer and increases the pressure inside the container 1.

The lid 4 is constructed from a plastics material and it covers the opening 3 of the glass 2 in a sealed manner in order to maintain the internal pressure. In particular, the material and thickness of the lid 4 is chosen by the skilled person so it is capable of withstanding the pressure inside the glass 2, while remaining malleable enough to be readily manually removable therefrom by hand.

In terms of the pressure seal between the glass 2 and the lid 4, reference is made to FIG. 3 which shows the rim 8 of the glass 2 in greater detail. In particular, the rim 8 comprises a rounded outwardly facing lip 9, and the lid 4 comprises a sealing area 10 adjacent to an outer edge 11 thereof, which overlies it. In particular, the sealing area 10 is folded down over a top 12 and a side 13 of the lip 9, and it comprises an inwardly facing flange portion 14 applied to a bottom 15 of the lip 9. A crimp 18 is then be applied to the flange portion 14 to seal it against the bottom 15 of the lip 9.

As is clear from FIGS. 1-7 the releasable section 5 is generally rectangular in shape, and comprises a first side 17 which is formed by a portion of the outer edge 11 of the lid 4. As such, as shown in FIG. 5, the aperture 6 is small and extends from the rim 8 of the glass 2 rather than from a location in the middle of the lid 4, as in known pressurized can constructions. The rest of the releasable section 5 is defined by a pair of parallel weakened sections 18 of the lid 4 extending from the outer edge 11 to a fold line 19 normal to the weakened sections 18. The weakened sections 18 comprise score lines formed into the moulded shape of the lid 4. In use, as explained further below, the releasable section 5 can be displaced from the remainder of the lid 4 by tearing it therefrom along the weakened sections 18, which are designed to perish under a pre-determined load. When this happens the releasable section 5 rotates about the fold line 19 into the position shown in FIGS. 5 and 6. The fold line 19 also comprises a score line formed into the moulded shape of the lid 4, however it is not configured to perish in use and the releasable section 5 remains connected to the remainder of the lid 4 in the open position shown in FIGS. 5 and 6. This allows for the releasable section 5 to be movable from the open position shown in FIGS. 5 and 6 back to a closed position like that shown in FIG. 1 in which the first side 17 is disposed in substantially the same position as it was in the sealed position. The lid 4 is not sealed in this configuration because the weakened sections 18 have perished, however closure of the aperture 6 in this way can still help to prevent general spillage of the beer from the glass 2.

In order to facilitate the above described movement of the releasable section 5 into the open position, as well as to perform other functions, an activation lever 20 is disposed between the lid 4 and the rim 8 of the glass 2. The lever 20 is constructed from a mild steel and comprises a handle 21, a mid-portion 22 connected to the releasable section 5, and the tail part 23 extending beyond the releasable section 5.

The lever 20 is manually movable from a stand-by position as shown in FIGS. 1 and 2 in which it is in sealing connection with the rim 8, to an activation position as shown in FIGS. 5 and 6 in which it is displaced from the rim 8. Referring to FIG. 4, which shows the interconnection between the rim 8 of the glass 2 and the lever 20 in greater detail, when the lever 20 is in the stand-by position the mid-portion 22 is folded down over the top 12 and side 13 of the lip 9, in order to provide an effective pressure seal. The mid-portion 22 is connected to the releasable section 5 by means of a raised T-shaped boss 24 which passes through the material of the lid 4. As shown in FIG. 1 a top 25 of the boss 24 is annular in shape. As such, manual movement of the lever 20 from its stand-by position to its activation position moves the releasable section 5 from its sealed position to its open position. As such, the releasable section 5 is movable to the open position by manual manipulation of the lever 20, rather than by direct manual manipulation thereof.

The lever 20 is made from a more rigid material than the lid 4. As such, manual movement of the lever 20 will result in distortion of the lid 4, and not the opposite. However, the lever 20 is also designed to change shape in use.

In particular, as is clear from FIGS. 1 and 2, in the standby position the handle 21 is arranged substantially parallel with the side of the glass 2, and therefore at an oblique angle to the mid-portion 22. The handle 21 is not quite parallel to the side of the glass 2, as it is in fact normal to a plane of the rim 8 so there is an angular difference between the side of the glass 2 and the handle 21 determined by the taper of the glass 2. However, in practice the handle 21 can be pushed back against the side of the glass 2 during manufacture, to ensure the most effective ergonomic shape for transportation and storage.

The handle 21 can then rotate relative to the mid-portion 22, such that the lever 20 can be bent by the user into more of a linear shape, as shown in FIG. 5. This is achieved by means of a lever fold line 26 formed in the lever 20. The lever 20 is configured to fold along the lever fold line 26 under less force than that required to displace the releasable section 5 from the remainder of the lid 4, which is in effect the force required to tear the lid 4 along the weakened sections 18. As such, when the user first moves the handle 21 it rotates outwardly from the glass 2 until it is substantially in a plane parallel with a plane occupied by the mid-portion 22. When it reaches this point it can rotate no more and further force applied thereto leads to the tearing of the weakened sections 18, and the movement of the releasable section 5 from the sealed position to the open position, as shown in FIGS. 5 and 6.

The tail part 23 carries a gas release vessel 27 thereon which performs the known functions of a widget. The gas release vessel 27 is an elongate generally rectangular container 28 mounted to the tail part 23. It's upper surface 29 has rounded ends 30 and 31, and it comprises a gas release aperture 32 formed in rounded end 31. It will be appreciated that this is at the opposite end of the lever 20 to the handle 21. The gas release aperture 32 is open to the internal area 33 of the container 1, and this is the case when the lever 20 is in the stand-by position shown in FIGS. 1 and 2, as well as in the activation position shown in FIGS. 5 and 6. This is relevant because after the lid 4 has been placed on the glass 2 during manufacture, with the lever 20 in the stand-by position and hence the gas release vessel 27 in the lid 4, the nitrogen which has been added to the beer to pressurize it emerges from therefrom and enters the gas release vessel 27. This occurs provided the glass 2 is arranged the right way up as shown in the Figures, because the force of gravity will maintain the beer in the glass 2, allowing the nitrogen to enter the gas release vessel 27 above.

In order to facilitate this the lid 4 comprises a raised housing section 34 inside which the gas release vessel 27 is disposed when the lever 20 is in the stand-by position. In particular, the raised housing section 34 has rounded sides 35, which generally correspond in shape to the rounded ends 30 and 31. However, the raised housing section 34 is slightly larger than the gas release vessel 27, such that a gas channel 36 is provided between the raised housing section 34 and the gas release vessel 27 to allow for the pressurized gas to emerge from the beer and be forced under pressure into the gas release vessel 27.

Referring to FIG. 1 it can be seen that the raised housing section 34 comprises an indented portion 37 at the radial location of the releasable section 5. This allows for the aperture 6 to be formed. It also allows space for the boss 24, and for a larger contact area between the mid-portion 22 of the lever 20 and the releasable section 5. It also provides a pair of parallel radially extending walls 38 which provide a degree of support for the fold line 19 when the releasable section 5 rotates about it.

When the lever 20 is moved from the stand-by position shown in FIGS. 1 and 2 to the activation position shown in FIGS. 5 and 6, the tail part 23 and the gas release vessel 27 are rotated down into the internal area 33 of the glass 2, and hence into the beer therein. During this movement the whole lever 20 rotates about an axis in the region of the fold line 19, by virtue of the connection between the lever 20 and the releasable section 5 provided by the boss 24. The exact position of the axis will depend on the particular distortion experienced by the lid 4 in question when the lever 20 is rotated and the releasable section 5 moved. As the lid 4 is constructed from a resilient plastics material this may vary. It may be in line with the fold line 19, or it may be slightly above it, below it, or proximal or distal to a central axis of the glass 2. It might also be at an angle to a plane of the rim 8 if the lid 4 experiences a twisting moment in use. This does not matter a great deal, as in any event the releasable section 5 will be displaced to form the aperture 6, and simultaneously the gas release vessel 27 will be immersed in the beer.

When the aperture 6 is formed the pressure inside the container 1 is released. This results in de-pressurization of the beer therein, causing gas in the liquid to expand and form bubbles. This also results in de-pressurization of the gas release vessel 27, causing the nitrogen therein to expand and force its way out of the gas release aperture 32. It will be appreciated that this happens as the gas release vessel 27 is being rotated down into the beer. The escape of gas from the gas release vessel 27 causes more bubbles to form in the beer, leading to the formation of a foamy head, in the known way. As the gas release aperture 32 is small, this process takes some time, which is part of the known functionality of a widget. As the gas release vessel 27 contains only the pressurized nitrogen, or it mostly does so depending on the previous orientation of the container 1, or the manner in which the container 1 was pressurized during manufacture, the widget function is of the enhanced type, forming a greater number of bubbles in the beer, and hence a better foamy head.

When the lever 20 is in the activation position shown in FIGS. 5 and 6 the handle 21 is located above the aperture 6. In this position the handle 21 can be moved back and forth in a reciprocating action by the user about its axis of rotation, which as explained above is in the region of the fold line 19. This allows the gas release vessel 27 to be manually agitated by the user, which can lead to an enhanced widget effect. This kind of manual manipulation of a widget has never been possible before.

Therefore, in use the container 1 operates as follows. During manufacture beer is first placed in the glass 2. The exact quantity will be a matter for the skilled person, however there is a consideration particular to this invention. In particular, while it is known to not completely fill a pressurized beverage container with a beverage, in order to leave some volume for expansion under pressure, and to ensure that excess beverage does not escape from the container when it is depressurized, in this case there is also the volume of the gas release vessel 27 to consider. In particular, when the gas release vessel 27 is rotated down into the beer it will displace a quantity of the beer equal to its own area. In order to ensure this does not lead to beer being ejected from the aperture 6, the quantity of beer placed in the glass 2 must be less than the internal volume of the glass 2 by at least the volume to be occupied by the gas release vessel 27, if not by an amount a little larger than this to accommodate for normal expansion during de-pressurization. This can all be a matter for the skilled person to calculate.

Once the beer has been placed in the glass 2, it is followed by a pre-determined quantity of liquid nitrogen. The lid 4, with the lever 20 in the stand-by position and the gas release vessel 27 inside the raised housing section 34, is then placed on the rim 8. Before being placed on the rim 8 the sealing area 10 of the lid 4 is a simple radially extending flange shape. Once the lid 4 is in place on the rim 8 a closure tool is operated to force the sealing area 10 of the lid 4 into the configuration shown in FIGS. 2 and 3. In particular, the inwardly facing flange 14 is formed, and the crimp 16 applied. This connection between the lid 4 and the glass 2 is strong enough to withstand the pressure inside the glass 2 as the liquid nitrogen turns to gas and increases the pressure therein. The tool also forces the mid-portion 22 of the lever 20 into contact with the lip 9, creating a similar seal, as shown in FIG. 4.

Shortly after the internal area 33 of the glass 2 has been sealed in this way the nitrogen inside forces its way through the gas channel 36 and the gas release aperture 32 and into the gas release vessel 27, as described above. If this is done with the container 1 the correct way up, only nitrogen, or mostly only nitrogen, enters the gas release vessel 27.

When the container 1 is to be opened for use the user applies a manual force to pull the handle 21 away from the side of the glass 2. Initially this results in the handle 21 rotating about the lever fold line 26 until the handle 21 is substantially in a plane parallel with a plane occupied by the mid-portion 22. This occurs because less force is required to rotate the handle 21 about the lever fold line 26 than is required to displace the releasable section 5 from the remainder of the lid 4. Once the handle 21 is in this position the force required to tear the weakened sections 18 is less than a force required to further bend the lever 20, and hence the lid 4 tears along the weakened sections 18 and the releasable section 5 moves into the open position shown in FIGS. 5 and 6.

The aperture 6 is then formed and the pressure inside the container 1 is released. As described above this results in de-pressurization of the beer therein, causing gas in the liquid to expand and form bubbles, and it also results in de-pressurization of the gas release vessel 27, causing the nitrogen therein to expand and force its way out of the gas release aperture 32. As the lever 20 is moved to the activation position shown in FIGS. 5 and 6 the gas release vessel 27 is rotated down into the internal area 33 of the glass 2, and hence into the beer therein. This rotation is about the fold line 19, or thereabouts as described above, and the speed of the movement is determined by the user as they tear the lid 4 along the weakened sections 18.

As this happens gas escapes from the gas release vessel 27, causing the formation of a foamy head in the known way. As the gas release aperture 32 is small, this process takes some time, and as the gas release vessel 27 contains only the pressurized nitrogen the widget function is of the enhanced type, forming a greater number of bubbles in the beer, and hence a better foamy head.

If desired the user can move the lever 20 back and forth in a reciprocating action, to further agitate the gas release vessel 27, which can lead to an enhanced widget effect.

The beer can then be consumed from the glass 2 in different ways. It can be consumed directly from the aperture 6, either by being poured therefrom, or by being sucked through a straw. If the lid 4 is left in place on the rim 8, then the user can close the aperture 6 by rotating the lever 20 back in the opposite direction. This does not result in the glass 2 being sealed again, as the weakened sections 18 have perished, but it may allow for some spillage to be prevented.

However, ideally once the foamy head has been formed and the widget function has ended, the used can simply remove the whole of the lid 4 from the glass 2, as shown in FIG. 7. This leaves a glass of beer with a foamy head, which can be consumed directly from the glass 2 in the known way. The lid 4 is removed by pulling the flange 14 away from the bottom 15 of the lip 9, against the force of the crimp 16, and then by bending or twisting the lid 4 free. This action can be readily performed by the user using their fingers and hands.

Once the beer has been consumer the glass 2 and the lid 4 can be disposed of.

The second aspect of the present invention relates to a lid for covering the opening of a receptacle part of a pressurized beverage container. The lid 4, which is shown separately from the glass 2 in FIG. 7, provides full support for the second aspect of the present invention. It will be appreciated how the lid 4 can be manufactured and sold separately to beverage manufacturers for fitment to their own glasses or other receptacles.

The first aspect of the present invention can be altered without departing from the scope of claim 1. For example, one alternative embodiment is shown in FIG. 8. In this case container 100 is the same as container 1, except that the gas release vessel 101 is pre-filed with pressurized gas prior to fitment of the lid 102 on the glass 103 during manufacture. This is an alternative possible manufacturing method which may be preferred. One advantage is that the nature and quantity of gas inside the gas release vessel 101 can be controlled, which may result in an enhanced functionality.

The gas release aperture (not visible) is closed with an adhesive strip 104. A rear side 105 of the adhesive strip 104 is then attached to an internal surface 106 of lid 102. As such, and as shown in FIG. 8, when the lever 107 is moved from the stand-by position to the activation position the adhesive strip 104 is removed from the gas release aperture so as to open it to the internal area 108. Therefore, the gas release aperture is opened simultaneously with the rotation of the lever 107, and hence the formation of the opening 109.

In other alternative embodiments (not shown) the lever operates differently to lever 20. In particular, in one alternative embodiment (not shown) the lever does not have a fold line and it maintains its substantially “L” shaped configuration during use, and in particular when the lever is moved from the stand-by position to the activation position. In an alternative to this (not shown) there is a lever fold line in the lever, but the force required to fold the lever is less than that required to displace the releasable section from the remainder of the lid. As such, all movement of the handle from the stand-by position to the activation position is transmitted to the mid-portion without the lever changing shape. However, when the tail part eventually abuts against an internal surface of the container it provides sufficient resistance to the lever that further force applied to the handle will fold it about the lever fold line relative to the mid-portion. This construction may be preferred because the lever is more resistant to folding and force applied to it will be directly applied to the lid.

A third embodiment of the present invention is shown in FIGS. 9-16, in which pressurized beverage container 110 is similar in general configuration to container 1 described above, but the tail part, in the form of discreet gas release vessel 111, is attached directly to the releasable section 112 of the lid 113, and there is no separate activation lever. This version is advantageous over the container 1 described above, because there are fewer parts, which reduces complexity and saves manufacturing costs. In addition, because the gas release vessel 111 is attached directly to the releasable section 112, the movement of the releasable section 112 is transmitted directly to the gas release vessel 111, which prevents any breakage or distortion in another area from hindering the transmission of the desired movement to the gas release vessel 111. Furthermore, the gas release vessel 111 can comprise an advantageously wide and annular shape as shown in FIGS. 9-16, and it can be disposed directly against an underside 114 of the lid 113 in the closed position, which saves space. In addition, the lack of the additional metal level part on the lid makes it more readily recyclable, and less likely to cause injury to the user or anyone who comes into contact with it after use.

The lid 113 is made from a moulded plastics material, and comprises an annular panel 115, with a downwardly depending flange portion 116 around an outer edge 117 thereof. Extending downwardly from one side of the flange portion 116 is a handle portion 118. The handle portion 118 is generally T-shaped in an axial direction, and it is also rounded in a circumferential direction so it follows the rounded shape of the glass 119. The lid 113 comprises the releasable section 112 which is manually movable from a sealed position as shown in FIG. 9 in which it forms a functional covering part of the lid 113, to an open position as shown in FIGS. 13 and 14 in which it is displaced from a remainder of the lid 113 such that an aperture 120 is formed in the lid 113.

A first side 121 of the releasable section 112 is formed by a portion of the outer edge 117 adjacent to the handle portion 118. The releasable section 112 is defined by weakened sections 122 of the lid 113 extending from the outer edge 117 to a fold line 123 which dissects the lid 113, and about which the releasable section 112 is rotatable. The exact position of the fold line 123 will depend on the particular distortion experienced by the lid 113 in question when the releasable section 112 is manipulated in use. As the lid 113 is constructed from a resilient plastics material this may vary. It may be in line with the fold line 123 as shown, or it may be slightly above it, below it, or proximal or distal to a central axis of the glass 119.

As shown in FIG. 11 the gas release vessel 111 is a separate part to the remainder of the lid 113, and is attached to the releasable section 112 by an adhesive 124. The adhesive connects a first end 125 of the gas release vessel 111 to a region, illustrated by hashed box 126, of a underside 127 of the releasable section 112 which is forward of the fold line 123. The region 126 changes position and/or orientation when the releasable section 112 is moved from the sealed position to the open position. As such a corresponding rotational movement is transmitted to the gas release vessel 111. Namely, when the releasable section 112 is rotated upwards as shown in FIG. 13, the gas release vessel 111 is rotated downwards so it travels inwardly into an internal area 128 of the glass 119.

As is clear from FIGS. 9-16 the opening 129 of the glass 119 is annular, in the known way, and the lid 113 is therefore also annular. However, in addition to this, the gas release vessel 111 is also annular, and is co-axial with the opening 129 when the lid 113 is mounted to the glass 119. The annular shape of the gas release vessel 111 allows it to have a large radial volume, so a sufficient internal volume can be achieved while maintaining a low height. As is clear from FIG. 12 the gas release vessel 111 has a generally dome-shaped lower surface 130, which is ergonomic and unlikely to cause any injury to the user or anyone else who comes into contact with it after use.

As is clear from FIG. 12, when the lid 113 is mounted on the glass 119 and the releasable section 112 is in the sealed position and the glass 119 is arranged with its opening 129 uppermost, the gas release vessel 111 is arranged above the beverage, which in this case is beer 131, in the glass 119. The gas release vessel 111 comprises a gas release aperture 132 at its second end 133 which is open to the internal area 128. Therefore, the gas release vessel 111 functions in the same was as gas release vessel 27 described above. Nitrogen introduced to the glass 119 during manufacture enters the gas release vessel 111, and when the releasable section 112 is moved to the open position the nitrogen escapes from the gas release aperture 132 and enters the beer 131.

The lid 113 comprises a sealing area 134 on the flange 116 which is in sealing connection with a rim 135 of the glass 119 when the lid 113 is in a mounted position thereon, as shown in FIG. 9. As is clear from the figures, the flange portion 116 is rounded in an axial direction, so as to encompass the rim 135 in an axial direction. The lid 113 is sufficiently malleable that it is manually removable from the glass 119, as shown in FIG. 16. This allows the user to completely remove the lid 112 to consume the beer 131 from the glass 119.

When the releasable section 112 is in the open position as shown in FIGS. 13-15 it extends upwardly from the remainder of the lid 113 and the gas release vessel 111 extends downwardly into the internal area 128. In this position the releasable section 112 can be moved back and forth in a reciprocating action by the user about its axis of rotation. This allows the gas release vessel 111 to be manually agitated by the user, which can lead to an enhanced widget effect. This kind of manual manipulation of a widget has never been possible before.

Therefore, in use the container 110 operates as follows. During manufacture beer 131 is first placed in the glass 119. The exact quantity will be a matter for the skilled person, however there is a consideration particular to this invention. In particular, while it is known to not completely fill a pressurized beverage container with a beverage, in order to leave some volume for expansion under pressure, and to ensure that excess beverage does not escape from the container when it is depressurized, in this case there is also the volume of the gas release vessel 111 to consider. In particular, when the gas release vessel 111 is rotated down into the beer 131 it will displace a quantity of the beer 131 equal to the portion of its own area immersed therein. In order to ensure this does not lead to beer being ejected from the aperture 120, the quantity of beer 131 placed in the glass 119 must be less than the internal volume of the glass 119 by at least the volume to be occupied by the gas release vessel 111, if not by an amount a little larger than this to accommodate for normal expansion during de-pressurization. This can all be a matter for the skilled person to calculate.

Once the beer 131 has been placed in the glass 119, it is followed by a pre-determined quantity of liquid nitrogen. The lid 113 is then placed on the rim 135 and a suitable sealing function applied to the sealing area 134. The connection between the lid 113 and the glass 119 is strong enough to withstand the pressure inside the glass 119 as the liquid nitrogen turns to gas and increases the pressure therein. Shortly after the internal area 128 of the glass 119 has been sealed in this way the nitrogen inside forces its way through the gas release aperture 132 and into the gas release vessel 111. If this is done with the container 110 the correct way up, only nitrogen, or mostly only nitrogen, enters the gas release vessel 111.

When the container 110 is to be opened for use the user applies a manual force to pull the handle portion 118 away from the side of the glass 119. The handle portion 118 is of sufficient structural strength that it maintains its general shape and orientation relative to the flange 116 when such force is applied, and transmits that force up to the releasable section 112, where it is transmitted to the weakened sections 122. The weakened sections 122 are then torn, leading to the releasable section 112 rotating about the fold line 123 and moving to the open position shown in FIGS. 13-15.

Referring to FIGS. 13-15, it will be appreciated that the releasable section 112 flexes as it is rotated due to the tensile strength of the material of the lid 113. Therefore, in some sense the releasable section 112 is “peeled” back as it is moved. It still rotates about the fold line 123 as this happens, but the region 126 of the underside 127 of the releasable section 112 to which the gas release vessel 111 is attached may also experience some rotation on its own axis (or on an axis in close proximity) due to this flexing, which movement will be transmitted to the gas release vessel 111. This is functionally immaterial because the gas release vessel 111 is still rotated down into the internal area 128 in the manner shown in the Figures.

The aperture 120 is formed and the pressure inside the container 110 is released. This results in de-pressurization of the beer 131 therein, causing gas in the liquid to expand and form bubbles, and it also results in de-pressurization of the gas release vessel 111, causing the nitrogen therein to expand and force its way out of the gas release aperture 132. As the releasable section 112 is moved to the open position shown in FIGS. 13-15 the gas release vessel 111 is rotated down into the internal area 128 of the glass 119, and hence into the beer 131 therein. This rotation is about the fold line 123, or thereabouts as explained above, and the speed of the movement is determined by the user as they tear the lid 113 along the weakened sections 122.

As this happens gas escapes from the gas release vessel 111, causing the formation of a foamy head in the known way. As the gas release aperture 132 is small, this process takes some time, and as the gas release vessel 111 contains only the pressurized nitrogen the widget function is of the enhanced type, forming a greater number of bubbles in the beer 131, and hence a better foamy head.

If desired the user can move the handle portion 118 back and forth in a reciprocating action, to further agitate the gas release vessel 111, which can lead to an enhanced widget effect.

The beer 131 can then be consumed from the glass 119 in different ways. It can be consumed directly from the aperture 120, either by being poured therefrom, or by being sucked through a straw. If the lid 113 is left in place on the rim 135, then the user can close the aperture 120 by moving the handle portion 118 back in the opposite direction. This does not result in the glass 119 being sealed again, as the weakened sections 122 have perished, but it may allow for some spillage to be prevented.

However, ideally once the foamy head has been formed and the widget function has ended, the user can simply remove the whole of the lid 113 from the glass 119, as shown in FIG. 16. This leaves a glass of beer with a foamy head, which can be consumed directly from the glass 119 in the known way. The lid 113 is removed by manually distorting it so the flange 116 is pulled away from the rim 135. This action can be readily performed by the user using their fingers and hands.

Once the beer has been consumed the glass 119 and the lid 113 can be disposed of.

The second aspect of the present invention relates to a lid for covering the opening of a receptacle part of a pressurized beverage container. The lid 113, which is shown separately in FIGS. 10, 11 and 15, provides full support for the second aspect of the present invention. It will be appreciated how the lid 113 can be manufactured and sold separately to beverage manufacturers for fitment to their own glasses or other receptacles.

Further alternative embodiments of the first aspect of the present invention are also possible. In particular, in alternative embodiments of the type in which the gas release vessel is sealed (not shown), the gas release aperture is opened using other mechanical techniques including being pierced as part of the movement of the lever, or being distorted as part of the movement of the lever so an opening is then created.

In other alternative embodiments of the present invention (not shown) the releasable section is entirely removable from the lid rather than remaining in contact herewith. In another alternative embodiment (not shown) the lid is applied to the glass with an adhesive.

In other alternative embodiments (not shown) the tail part comprises other functions associated with immersion in a beverage, including the introduction of an ingredient, a colourant or any kind of physical trigger which changes the nature, condition or temperature of the beverage or creates some other physical effect. In one particular version of this the tail part comprises a refrigeration device for cooling the beverage disposed in the receptacle. In another particular version of this the tail part comprises a gas release vessel and a refrigeration device, so the widget effect is combined with a cooling effect and a foamy head is generated at the same time as the beverage is cooled to enhance the consumption experience.

Three specific embodiments are described above, but it will be appreciated that any of their features, or any of those features mentioned above as alternatives, can be combined to form further alternative embodiments which all fall within the scope of claim 1. For example, a container can be like container 1, except that the lid is applied with an adhesive and the tail part carries a refrigeration device. Or, a container can be like container 110 except that the tail part comprises a colourant device, and the releasable section is entirely removable from the lid.

Furthermore, it will also be appreciated how the second aspect of the present invention can be provided in the form of lid 102 described above, and also that any of the above described lid features can be combined to provide various different lid constructions which would fall within the scope of claim 20 below.

Therefore, the present invention provides a pressurized beverage container which can be opened by moving the releasable section to the open position, much in the known way, but which at the same time involves moving the tail part so its function associated with immersion in a beverage is performed. This allows for a pressurized beverage container to produce a foamy head for a beer content, which can also be consumed as if from a glass. Furthermore, the lid can also then be removed, allowing the container to be used in the conventional manner by drinking or pouring from the opening, but also in the manner of a glass or mug if preferred. The invention also provides a novel widget arrangement involving the disposal of the widget above the beverage, and the rotation down into it as part of the opening process. The widget can be manually agitated, and it can be completely removed from the beverage for consumption.

1. A pressurized beverage container comprising a receptacle with an internal area, an opening and a lid covering said opening, in which said lid comprises a releasable section which is manually movable from a sealed position in which it forms a functional covering part of said lid, to an open position in which it is displaced from a remainder of said lid such that an aperture is formed in said lid,
in which said lid comprises a tail part, in which said tail part is movably associated with said releasable section such that during at least part of said manual movement of said releasable section from said sealed position to said open position said tail part travels inwardly into said internal area, and in which said tail part comprises a function associated with immersion in a beverage.

2. A pressurized beverage container as claimed in claim 1 in which a beverage is disposed in said internal area, and in which said tail part extends from said releasable section and is arranged above said beverage when said releasable section is in said sealed position and said container is arranged with said opening uppermost.

3. A pressurized beverage contained as claimed in claim 2 in which said tail part is attached to said releasable section by a connection mechanism, and in which said tail part is attached to a region of an underside of said releasable section which changes position and/or orientation when said releasable section is moved from said sealed position to said open position, such that a corresponding movement is transmitted to said tail part.

4. A pressurized beverage container as claimed in claim 1 in which said releasable section is manually rotatable about an axis dissecting said lid, such that said releasable section rotates upwardly from said remainder of said lid and said tail part rotates downwardly into said internal area when said releasable section is moved from said sealed position to said open position and said container is arranged with said opening uppermost.

5. A pressurized beverage container as claimed in claim 1 in which said lid is manually removable from said container.

6. A pressurized beverage container as claimed in claim 1 in which said tail part comprises a gas release vessel for releasing pressurized gas into a beverage disposed in said receptacle in use.

7. A pressurized beverage container as claimed in claim 6 in which said gas release vessel comprises a gas release aperture which is open to said internal area.

8. A pressurized beverage container as claimed in claim 1 in which said tail part comprises a refrigeration device for cooling a beverage disposed in said receptacle in use.

9. A pressurized beverage container as claimed in claim 1 in which said tail part comprises a gas release vessel for releasing a pressurized gas into a beverage disposed in said receptacle in use and a refrigeration device for cooling said beverage.

10. A pressurized beverage container as claimed in claim 1 in which said opening is annular, in which said lid is annular, and in which said tail part is annular and co-axial with said opening.

11. A pressurized beverage container as claimed in claim 1 in which said lid is constructed from a resilient material such that it is manually removable from said receptacle by being manually distorted.

12. A pressurized beverage container as claimed in claim 1 in which said lid comprises an outer edge, in which a first side of said releasable section is formed by a portion of said outer edge.

13. A pressurized beverage container as claimed in claim 12 in which said releasable section is defined by weakened sections of said lid extending from said outer edge to a fold line about which said releasable section is rotatable.

14. A pressurized beverage container as claimed in claim 13 in which said releasable section remains connected to said remainder of said lid in said open position, and in which said releasable section is movable from said open position back to a closed position in which said first side is disposed in substantially the same position as it was n said sealed position.

15. A pressurized beverage container as claimed in claim 1 in which said lid comprises a sealing area adjacent to an outer edge thereof which is in sealing connection with a rim of said receptacle when said lid is in a mounted position on said receptacle, in which an activation lever is disposed between said lid and said rim, which lever is movable from a stand-by position in which it is in sealing connection with said rim to an activation position in which it is displaced from said rim, and in which said lever is connected to said releasable section such that movement of said lever from said stand-by position to said activation position moves said releasable section from said sealed position to said open position.

16. A pressurized beverage container as claimed in claim 15 in which said lever comprises a handle, a mid-portion connected to said releasable section, and said tail part extending beyond said releasable section.

17. A pressurized beverage container as claimed in claim 16 in which said tail part carries a gas release vessel for releasing pressurized gas into a beverage disposed in said receptacle, in which said lid comprises a raised housing section inside which said gas release vessel is disposed when said lever is in said stand-by position, such that it is arranged above said beverage when said container is arranged with said opening uppermost.

18. A pressurized beverage container as claimed in claim 17 in which said gas release vessel comprises a gas release aperture which is closed to said internal area when said lever is in said stand-by position, in which said gas release aperture is closed with an adhesive strip, in which a rear side of said adhesive strip is attached to said lid, and in which when said lever is moved from said stand-by position to said activation position said adhesive strip is removed from said gas release aperture so as to open it to said internal area.

19. A pressurized beverage container as claimed in claim 17 in which said rim comprises a rounded outwardly facing lip, in which said sealing area comprises a portion of said lid which is sealed to a portion of said lip, in which in said stand-by position said handle is arranged substantially parallel with a side of said receptacle and at an oblique angle to said mid-portion.

20. A lid for covering an opening of a receptacle part of a pressurized beverage container containing a beverage disposed in an internal area thereof, in which said lid comprises a releasable section which is manually movable from a sealed position in which it forms a functional covering part of said lid, to an open position in which it is displaced from a remainder of said lid such that an aperture is formed in said lid,
in which said lid comprises a tail part, in which said tail part is movably associated with said releasable section such that during at least part of said manual movement of said releasable section from said sealed position to said open position said tail part travels inwardly into an internal area of a receptacle part with which it is used, and in which said tail part comprises a function associated with immersion in a beverage.
